(19) United States
(12) Patent Application Publication
(10) Pub. No.: US 2002/0181106 A1
(43) Pub. Date: Dec. 5, 2002

(54) System and method for tunable dispersion compensation

(76) Inventors: Tiejun Xia, Richardson, TX (US); Kuang-Yi Wu, Plano, TX (US); Gan Zhou, Plano, TX (US); Chi-Hao Cheng, Dallas, TX (US)

Correspondence Address: BAKER BOTTS L.L.P., 2001 ROSS AVENUE, SUITE 600, DALLAS, TX, 75201-2980, US

(21) Appl. No.: 09/872,315

(22) Filed: Jun. 1, 2001

(51) Int. Cl. G02B 27/00; G02B 1/10

(52) U.S. Cl. 359/578; 359/584

(57) ABSTRACT

The present invention relates to a system and method for tunable dispersion compensation that uses a first reflective surface and a second reflective surface. The first reflective surface has a gradient reflective index and receives an input signal at an incident position. The first reflective surface and the second reflective surface process the input signal according to a dispersion function that is based at least in part upon the incident position of the input signal.

### BACKGROUND

At the present time, optical communication has gained increased prominence in numerous fields. For instance, optical networking has become important to facilitate high capacity communication links. Optical networking has been frequently utilized to provide communication links for Internet traffic. Optical networking has provided significant advantages in traditional voice telephony applications. In such applications, it is frequently necessary to provide an optical signal over significant distances (e.g., hundreds of kilometers).

However, optical communication systems disposed over significant distances present several unique challenges. In particular, optical communication systems exhibit dispersion. Dispersion is caused by the propagation characteristics of the optical medium (e.g., the optical fiber). There are three essential dispersion mechanisms associated with optical media. First, internodal dispersion refers to the difference in the propagation characteristics between different propagation modes of the same wavelength of an optical signal. Waveguide dispersion refers to the difference in propagation characteristics (mode angles and path lengths) that are wavelength dependent. Also, optical or chromatic dispersion refers to the wavelength dependent variation in the propagation of a modulated wave in a medium. In particular, the index of refraction is a function of wavelength thereby effecting wavelength dependent propagation characteristics. In optical fibers, optical or chromatic dispersion is the dominant dispersion mechanism, since intermodal dispersion is typically limited by utilizing single mode fibers.

Various approaches have been developed to address dispersion effects in optical systems. First, fiber matching techniques have been developed. In fiber matching systems, fibers possessing opposite dispersion characteristics are utilized. For example, a first fiber may cause lower wavelengths to be associated with a lower group velocity, while a second fiber may cause lower wavelengths to be associated with a higher group velocity. The opposing group velocity characteristics are achieved by appropriate doping of the fibers. By causing an optical signal to propagate through links alternately utilizing the first fiber and the second fiber, the dispersion effects may be balanced. However, this is problematic for several reasons. First, the amount of dispersion compensation that is required is not known until the fiber is actually placed in the ground. Secondly, the dispersion compensation is not tunable, since the dispersion characteristics are the result of rigid physical parameters such as, the length and other properties of the optical fibers.

Dispersion compensation chirped grating filters have also been utilized. Grating filters provide a degree of tunable dispersion compensation by variably expanding the gratings of the filter. However, grating filters are problematic. First, grating filters produce ripples in the filter response due to diffraction phenomenon. Grating filters also require temperature control to function properly. Grating filters also are associated with a host of cumbersome manufacturing issues. Accordingly, grating filters are not particularly stable devices.

Virtual Image Phased Array (VIPA) is another technique that has been utilized to achieve a degree of dispersion compensation. VIPA provides angular dispersion to the light via multiple reflection inside the VIPA apparatus. However, VIPA possesses several disadvantages. First, VIPA systems possess high insertion loss characteristics. Also, VIPA systems are associated with significant reliability concerns.

Another technique to address dispersion compensation is described as an all-pass filter approach as detailed in chapters 1-6 of Optical Filter Design and Analysis: A Signal Processing Approach by Christi K. Madsen et al. However, this all-pass filter approach is very sensitive to the environment. Accordingly, this approach is sub-optimal, since it is not sufficiently stable for many practical applications.

### SUMMARY OF THE INVENTION

Some, none, or all of the embodiments of the present invention may embody the following technical advantages. Specifically tunable dispersion compensation may be provided to an optical signal. The tunable dispersion compensation may occur in response to variations in the incident position of an optical signal. This is partly due to the gradient reflective index associated with the dispersion compensation. Also, tunable slope dispersion compensation may be provided to address distinct wavelength channels of an optical signal. The dispersion compensation is mechanically stable and is not dependent upon thermal conditions.

In one embodiment, the present invention is directed to a dispersion compensator having a first reflective surface and a second reflective surface. The first reflective surface has a gradient reflective index and receives an input signal at an incident position. The first reflective surface and the second reflective surface process the input signal according to a dispersion function that is based at least in part upon the incident position of the input signal.

In another embodiment, the present invention is directed to a method for providing dispersion compensation. The method comprises receiving an input signal at an incident position along a first reflective surface having a gradient reflective index. The method continues by reflecting a first portion of the input signal at the first reflective surface and reflecting a second portion of the input signal at a second reflective surface. The method concludes by generating an output signal that comprises the first and second portions of the input signal. The output signal exhibits a dispersion response that is based at least in part upon the incident position of the input signal.

In yet another embodiment, the present invention is directed to a dispersion compensator that includes a first reflective surface, a second reflective surface, and a third reflective surface. The first reflective surface has a gradient reflective index and receives an input signal at an incident position. The second reflective surface has a gradient reflective index and is arranged substantially parallel to the first reflective surface. The third reflective surface is arranged substantially parallel to the second reflective surface. The first, second, and third reflective surfaces of the dispersion compensator process the input signal according to a dispersion function that is based at least in part upon the incident position of the input signal.

In still another embodiment, the present invention is directed to a dispersion compensator including a first etalon unit and a second etalon unit. The first etalon unit includes a first reflective surface having a gradient reflective index. The first reflective surface receives a first optical signal at an incident position. The first etalon unit further includes a second reflective surface such that the first reflective surface and the second reflective surface process the first optical signal to generate a second optical signal having a dispersion response that is based at least in part upon the incident position of the first optical signal. The second etalon unit includes a third reflective surface having a gradient reflective index. The third reflective surface receives the second optical signal at an incident position. The second etalon unit further includes a fourth reflective surface such that the third reflective surface and the fourth reflective surface process the second optical signal to generate a third optical signal having a dispersion response that is based at least in part upon the incident position of the second optical signal.

### BRIEF DESCRIPTION OF THE DRAWING

For a more complete understanding of the present invention, reference is now made to the following descriptions taken in conjunction with the accompanying drawing, in which:

FIG. 1 depicts a spectrum representation of the output of a laser diode;

FIG. 2A depicts an initial optical pulse in an optical fiber;

FIG. 2B depicts optical pulse spreading phenomenon in an optical fiber;

FIG. 3A depicts a series of optical pulses associated with signal periods;

FIG. 3B depicts intersymbol interference due to dispersion spreading of optical pulses;

FIG. 4A depicts one embodiment of an etalon unit;

FIG. 4B depicts one embodiment of a continuous gradient coating;

FIG. 4C depicts one embodiment of a step gradient coating;

FIG. 5 depicts an exemplary overlay of a group delay response curve associated with the etalon unit and an output curve associated with a laser diode;

FIG. 6 depicts one embodiment of a cascaded arrangement of etalon units;

FIG. 7 depicts one embodiment of a group delay response curve associated with a plurality of etalon units;

FIG. 8 depicts exemplary group delay as a function of wavelength;

FIG. 9 depicts exemplary dispersion as a function of incident position;

FIG. 10 depicts one embodiment of a serial arrangement of gradiently coated etalons;

FIG. 11 depicts a flowchart for a computer aided etalon parameter selection algorithm; and

FIG. 12 depicts exemplary multi-channel dispersion compensation for a particular incident position utilizing dispersion slope compensation.

### DETAILED DESCRIPTION

Dispersion is problematic due partly to the non-ideal nature of laser diodes utilized in optical systems. Specifically, laser diodes do not produce light that is perfectly bandlimited to a specific wavelength. Instead, laser diodes produce optical signals that span a relatively narrow portion of the wavelength spectrum. FIG. 1 depicts a typical wavelength domain representation of the output of a laser diode. FIG. 1 shows that output 100 is centered at λ_{c}. Output 100 is typically approximated by a Gaussian curve centered at λ_{c}. Output 100 possesses significant optical power adjacent to λ_{c}. However, output 100 is substantially attenuated at wavelengths beyond λ_{c}+λ_{b} and λ_{c}−λ_{b}.

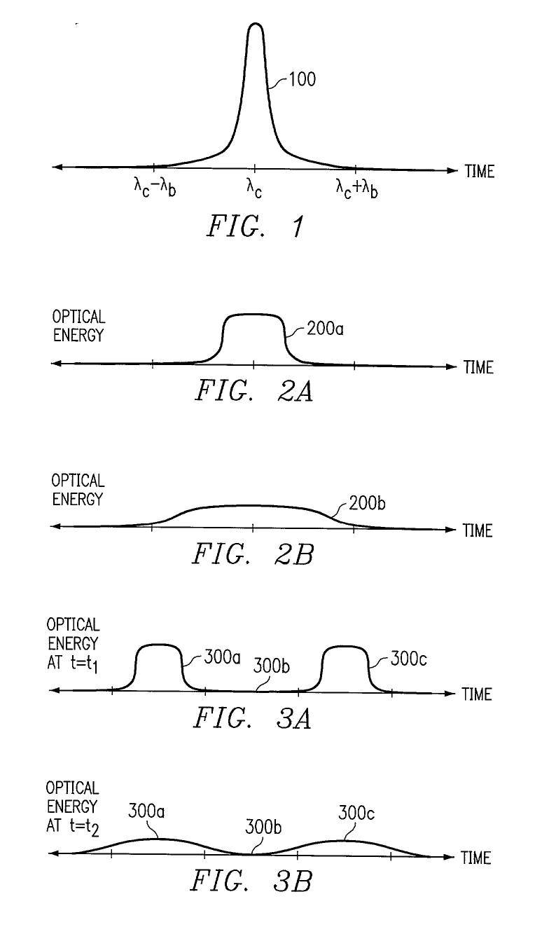

Utilizing output 100 as an example, an output pulse from a laser diode will experience dispersion due to the various wavelength components of output 100. FIG. 2A depicts a representation of an optical pulse in an optical fiber. Pulse 200a depicts the initial shape of the optical energy immediately after generation by a laser diode and after being launched into an optical fiber. After propagation through the optical fiber, the various wavelength components are transmitted at different rates. Accordingly, the optical energy associated with the particular pulse is spread in the time domain. Pulse 200b illustrated in FIG. 2B depicts the spreading of an optical pulse in the time domain due to dispersion after propagation through a portion of an optical fiber. It shall be appreciated that dispersion effects increase as a function of time which is related to propagation distance.

The spreading of optical pulses, such as pulse 200a, causes significant difficulties in optical detection (the recovery of data from the modulated optical signal). First, the spreading of the optical energy is associated with a decreased signal to noise ratio. This is especially problematic when optical amplifiers are utilized at various optical links. Secondly, dispersion may cause optical energy associated with a particular symbol (an analog pulse of a defined duration used to represent digital information) to interfere with optical energy associated with another symbol. FIGS. 3A and 3B depict intersymbol interference. In FIG. 3A, optical symbol periods 300a, 300b, and 300c in an optical fiber are shown at t=t₁. The symbol sequence represents the following bit pattern: 1, 0, 1, since an optical pulse is present in optical symbol periods 300a and 300c while no optical pulse is present in optical symbol period 300b. In FIG. 3A, the symbols are well defined since the optical energy is well confined to the respective symbol periods. FIG. 3B depicts the effect of dispersion on optical symbol periods 300a, 300b, and 300c at t=t₂ where t₂>t₁. Since t₂>t₁, the optical pulses have propagated through a portion of the optical fiber. Thus, dispersion has caused the energy of the various optical pulses to spread during propagation through the optical fiber. Optical energy is now present within the symbol period 300b. Accordingly, an optical detector may produce an error during the detection process. Specifically, the presence of optical energy within the optical period 300b may cause an optical detector to detect 1 instead of 0 thereby corrupting the transmitted data. Similarly, significantly less optical energy is present with optical periods 300a and 300c. Accordingly, an optical detector may detect 0 instead of 1 for optical periods 300a and 300c.

One reason why an optical pulse spreads as described with respect to FIGS. 3A and 3B is the fact that optical media possess inhomogeneous optical characteristics. Specifically, optical media, such as optical fibers, possesses indexes of refraction that are a function of frequency. This causes certain frequencies to propagate more quickly than other frequencies thereby causing optical spreading or dispersion.

It shall be appreciated that a modulated signal (e.g., a signal modified to carry information via a signal envelope) possesses distinct propagation characteristics. Specifically, the velocity of propagation of an envelope produced when an electromagnetic wave is modulated by, or mixed with, other waves of different frequencies is called group velocity. Group velocity does not equal phase velocity (the velocity of propagation of a “pure” or single frequency sinusoidal signal) in most optical media, since the index of refraction is non-linearly frequency dependent in most optical media. Moreover, group velocity is frequency dependent, since the index of refraction of optical media is frequency dependent. Mathematically, group velocity is given by the partial derivative dw/dk (wherein w is the phase velocity and k is the wave vector).

The delay of propagation of an envelope produced when an electromagnetic wave is modulated by, or mixed with, other waves of different frequencies is called group delay. Group delay is necessarily time dependent, since group delay is dependent upon the distance of propagation. Specifically, a signal will experience greater group delay when the signal propagates a longer amount of time. Group delay equals distance of propagation divided by group velocity. Mathematically, group delay is given by the partial derivative dk/dw multiplied by the propagation distance.

As previously noted, dispersion is qualitatively the amount of spreading of an optical pulse. Dispersion occurs, because group delay is frequency dependent. In particular, certain frequency components of an optical pulse are delayed longer than other frequency components thereby causing such frequency components to spread or disperse from each other. Dispersion is related to group delay and the bandwidth of an optical pulse, i.e., the width of the frequency composition of the optical pulse. Specifically, dispersion increases as the difference between group delay of different frequency components of an optical pulse increases. Mathematically, dispersion is given by the partial derivative dτ/dk (where τ is group delay).

Compensation for dispersion caused by an optical fiber or otherwise is effected by selecting a filter or other optical device that provides opposite dispersion characteristics to the dispersion characteristics of an optical media (e.g., an optical fiber). Dispersion characteristics of silica-based optical fibers are well known. In particular, the dispersion characteristics for silicia-based optical fibers have been determined on numerous occasions through empirical testing. Qualitatively, an optical fiber may cause certain lower frequency components to travel faster than higher frequency components for a given optical channel. A dispersion compensating filter for this channel would then cause higher frequency components of the optical channel to travel faster than lower frequency components to compensate for the dispersion characteristics of the optical fiber. Thus, dispersion compensation is achieved by appropriately selecting the physical characteristics of the optical filter or other dispersion compensation device in relation to known dispersion effects. Embodiments of the present invention achieves dispersion compensation by selectively choosing physical characteristics of an etalon dispersion compensation system. Details regarding selecting such physical characteristics of an etalon dispersion compensation system shall be provided with respect to FIG. 11.

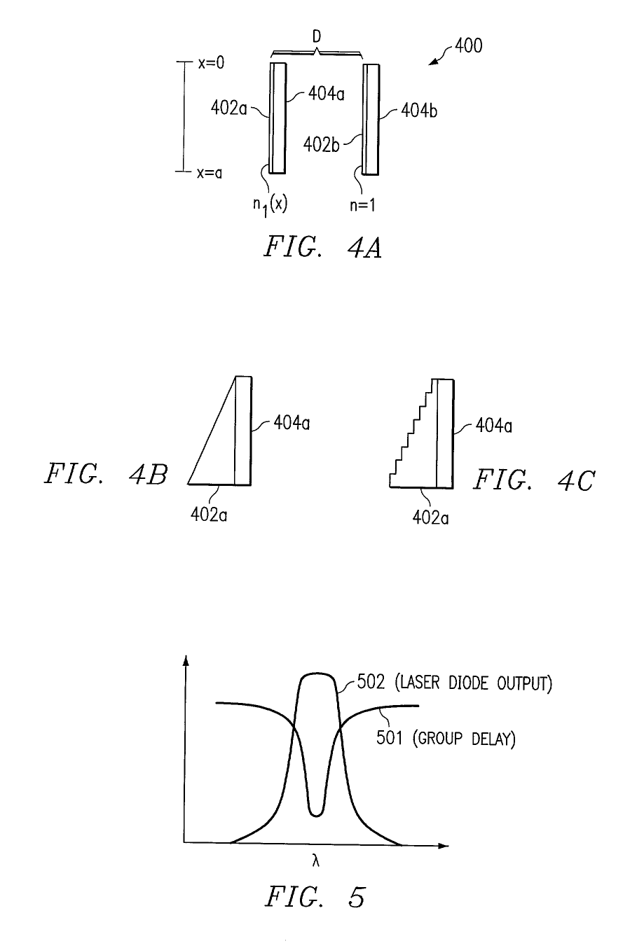

FIG. 4 depicts exemplary etalon unit 400 arranged according to an embodiment of the present invention. Etalon unit 400 comprises reflective surfaces 402a and 402b that are separated by a distance, D. In one embodiment reflective surfaces 402a and 402b may be formed upon optical components 404a and 404b, respectively. In general, etalon unit 400 provides wavelength dependent and incident position (the position, x, where a signal is incident upon etalon unit 400) dependent group delay response thereby facilitating tunable dispersion compensation upon the incident signal. In particular, variable group delay is provided by etalon unit 400 as a function of x (wherein x defines the incident position of a signal) thereby providing tunable dispersion compensation. Further details of etalon unit 400 are provided below.

Optical components 404a and 404b generally provide support for reflective surfaces 402a and 402b. In one embodiment, components 404a and 404b comprise glass or any other material that is transparent and generally does not affect the propagation of an optical signal. Other transparent support structures may be utilized by persons of ordinary skill in the art. Additionally, components 404a and 404b are not required to practice the present invention. Reflective surfaces 402a and 402b form a cavity that may be filled with air or some other material, or alternatively, the etalon cavity may be a vacuum.

Reflective surfaces 402a and 402b comprise materials that provide any suitable degree of reflectivity. The reflectivity of surface 402a or 402b is indicated by a reflective index (n) which defines the portion of incident light that is reflected by that surface 402a or 402b. The reflective index (n) of reflective surface 402b, for example, is equal to one or is approximately equal to one to thereby cause almost all incident optical energy to be reflected. The reflective index (n₁(x)) of reflective surface 402a is a function of x where x is defined as being a distance from the top or equivalently the bottom of surface 402a as shown in FIG. 4A. Specifically, reflective surface 402a possesses a gradient reflective index (d/dx n₁(x)≠0). As an example, reflective surface 402a may be gradiently coated such that n₁(x=0)=0.2 while n₁(x=a)=0.6 where “a” is another position along surface 402a.

The gradient of the reflective index associated with reflective surface 402a may be configured according to any suitable function. In one embodiment, the gradient of the reflective index associated with reflective surface 402a is a continuous function as illustrated in FIG. 4B. In another embodiment, the gradient of the reflective index associated with reflective surface 402a is a step function as illustrated in FIG. 4C. Still, other functions may be used to configure the gradient of the reflective index associated with surface 402a. The reflective characteristics of reflective surfaces 402a and 402b may be implemented using appropriate dielectric materials or dielectric films which are well known in the art. Suitable materials for such dielectric coatings include oxides, fluorides, sulfides, tellurides, and selenides. It shall be appreciated that persons of ordinary skill in the art may use any number of other materials or techniques to achieve the reflective characteristics of reflective surfaces 402a and 402b and any such materials and techniques are intended to be within the scope of the present invention.

According to this configuration, etalon unit 400 exhibits desirable optical properties. First, it shall be noted that etalon unit 400 is essentially a lossless device, since n, the reflective index of reflective surface 402b is approximately equal to one. Therefore, almost all of the energy of the optical signal is reflected by etalon unit 400. Secondly, the wavelength dependent group delay of etalon unit 400 may be tunably selected to provide a particular dispersion response function that compensates for the dispersion caused elsewhere in an optical network, such as by an optical fiber. The wavelength dependent group delay and dispersion characteristics are the result of quantum mechanics limitations created by reflective surfaces 402a and 402b and the separation distance, D, of etalon unit 400. An optical signal processed by etalon unit 400 exhibits group delay (τ(x)) given by the following relationship:

τ(x)=−2rT(r+cos ωT)/(1+r²+2r cos ωT)

where r² is the power reflectivity defined by the power transfer function associated with etalon unit 400, r is the positive square root of r², and T is the round trip delay of etalon unit 400 which equals 2n₁(x)D/c (D is the separation distance, n₁(x) is the reflective index of reflective surface 402a, and c is the speed of light in the etalon cavity).

The tunability of the group delay response and, hence, the dispersion response function of etalon unit 400 arises because T is a function of the reflective index of surface 402a. Moreover, the reflective index of surface 402a is a function of the incident position of the optical signal as a result of the gradient coating associated with surface 402, as described with respect to FIGS. 4B and 4C. Thus, modification of the incident position of an optical signal along surface 402a changes the reflective index and the group delay response of the etalon unit 400 to thereby tune the dispersion characteristics of the optical signal.

Moreover, the group delay response of etalon unit 400 is a function of frequency and, hence, wavelength. However, it shall be appreciated that the group delay response of a single etalon unit may be relatively narrow when compared to the output of a laser diode. For example, FIG. 5 depicts an exemplary overlay of a group delay response 501 of an etalon unit 400 with the output response 502 of a laser diode. Since group delay response 501 only experiences significant variation over a limited portion of the wavelength spectrum occupied by output 502, group delay response 501 may not be optimally effective for providing dispersion compensation to a signal originating from a laser diode that produces output 502. Accordingly, embodiments of the present invention utilize a plurality of etalon units 400 in various configurations to achieve tunable dispersion compensation for a sufficient portion of the wavelength spectrum associated with one or more particular optical channels.

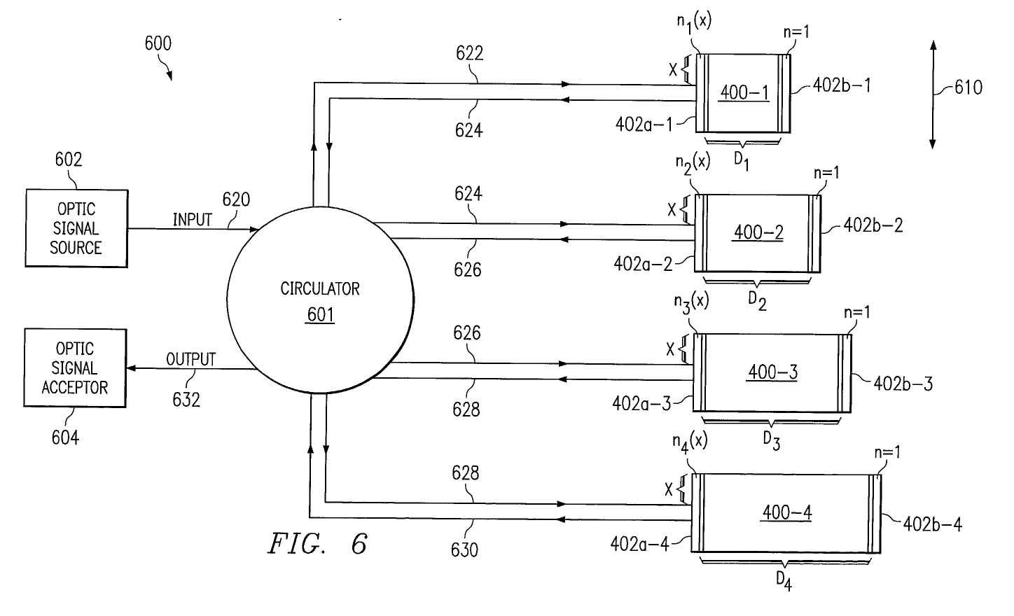

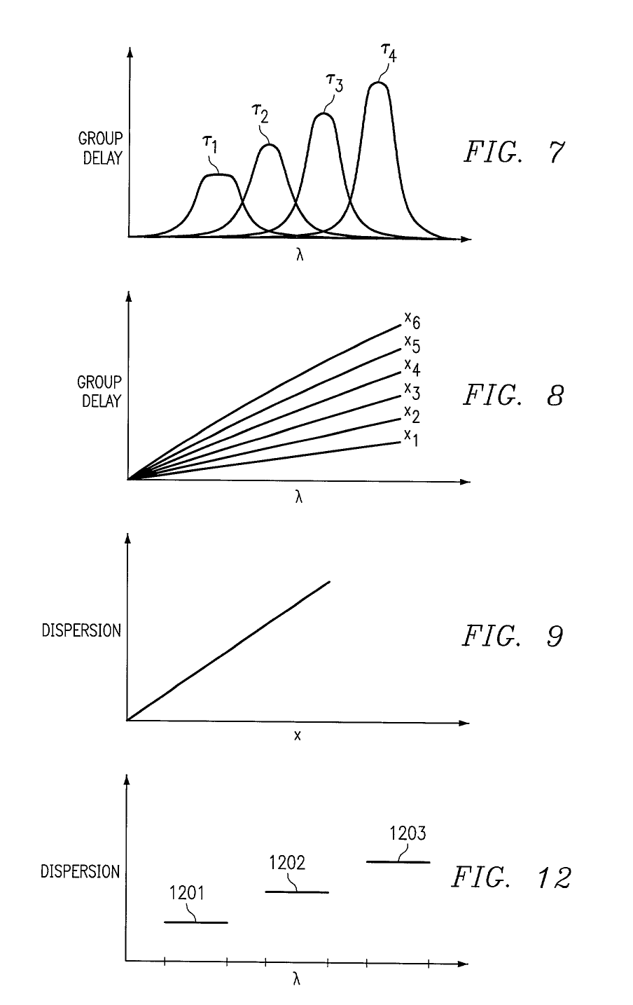

FIG. 6 depicts a block diagram of an embodiment of the present invention that uses a plurality of etalon units 400 to provide dispersion compensation according to a dispersion response function. Specifically, FIG. 6 depicts system 600 which uses an exemplary cascaded implementation of a plurality of etalon units 400 to provide tunable dispersion compensation for one or more optical wavelength channels. System 600 comprises optical signal source 602, circulator 601 for spatially separating optical signals, cascaded etalon units 400-1 through 400-4, and optical signal acceptor 604.

Optical signal source 602 provides an incoming optical signal 620 having one or more wavelength channels. Optical signal source 602 may be, for example, associated with a link in an optical network. Optical signal source 602 may be associated with other optical components such as beam splitters, channel splitters, optical switches, and/or the like. Optical signal acceptor 604 may be any optical component, device, or system that accepts output optical signal 632. For example, optical signal acceptor 604 may be associated with an optical detector or an optical amplifier. Optical signal acceptor 604 may be associated with another link in an optical network. The preceding applications are merely exemplary and are not intended to limit the use of the present invention.

As previously noted, etalon units 400-1 through 400-4 provide wavelength dependent group delay upon optical signals. Etalon units 400-1 through 400-4 are associated with functions n₁(x) through n₄(x), respectively defining the reflective index of reflective surfaces 402a-1 through 402a-4. Also, the reflective index of reflective surfaces 402b-1 through 402b-4 equal one or approximately one thereby causing almost all of the optical energy that reaches reflective surfaces 402b-1 through 402b-4 to be reflected. Etalon units 400-1 through 400-4 are respectively associated with separation distances D₁ through D₄. It shall be appreciated that system 600 is not depicted to scale in order to aid the reader's comprehension of system 600. Specifically, separation distances D₁ through D₄ may exhibit spatial differences on the nanometer scale in actual implementations. It shall further be appreciated that although system 600 consists of four etalon units 400, the present invention is not limited to any particular number of etalon units.

Circulator 601 is a well known device in the art. Circulator 601 provides a mechanism to spatially separate input and output optical signals. Other mechanisms may be utilized to achieve desired spatial separation. For example, a dual fiber collimator may be utilized in connection with off-angle mirrors or reflective surfaces. Other spatial separation techniques may be implemented by those possessing ordinary skill in the art and such techniques are intended to be within the scope of the present invention. In this embodiment, circulator 601 provides the optical signal to each etalon unit 400 in a serial manner. Also, it shall be appreciated that system 600 is not represented utilizing the exact geometry associated with an actual implementation. Instead, system 600 is represented as a logical block diagram to aid the reader's understanding of the operations of system 600.

System 600 provides tunable dispersion compensation upon signal 620 by physically translating one or more etalon units 400-1 through 400-4 in a direction indicated by arrow 610 to change the incident position of a respective optical signal. Specifically, physical translation of etalon unit 400 causes each respective optical signal to be incident upon an associated reflective surface 402a at a particular incident position, x. Although the following description of FIG. 6 is detailed with respect to incident position, x, of each optical signal being the same among the plurality of etalon units 400-1 through 400-4, the incident position, x, of each respective optical signal may vary among the plurality of etalon units 400 to provide the appropriate dispersion compensation to the optical signals. By performing such a translation, an input optical signal may experience various reflective indexes at reflective surfaces 402a-1 through 402a-4 due to the respective gradient reflective indexes. It shall be appreciated that the present invention does not require physical translation of etalon units 400. Instead, persons of ordinary skill in the art may apply other mechanisms to cause an optical signal to be variably translated with respect to etalon units 400-1 through 400-4 to achieve a desired incident position, and such mechanisms are intended to be within the scope of the present invention.

In operation, circulator 601 receives optical signal 620 from optical signal source 602 and redirects the optical signal as optical signal 622 to etalon unit 400-1. A portion of optical signal 622 is reflected by reflective surface 402a-1. The remaining portion of optical signal 622 is transmitted until reflected by reflective surface 402b-1. It shall be appreciated that optical resonance occurs in the cavity of etalon unit 400-1 due to multiple reflections between reflective surfaces 402a-1 and 402b-1. Additionally, it shall be appreciated that all or substantially all of the energy associated with optical signal 622 is reflected regardless of wavelength, but the group delay of the signal is dependent on wavelength. Moreover, the specific portion of energy initially reflected by reflective surface 402a-1 is tunable due to the gradient reflective index of reflective surface 402a-1.

Optical signal 624 represents the superposition or combination of reflected signal portions returning from etalon unit 400-1. Thus, at this point, optical signal 624 has experienced group delay as defined by the incident position of signal 622. The process of redirecting the optical signal to various incident positions along reflective surfaces 402a of the remaining etalon units 400 is repeated. In this respect, the appropriate optical signals experience additional group delay associated with each remaining etalon units 400-2 to 400-4. In particular, circulator 601 provides optical signals 624, 626, and 628 to etalon units 400-2, 400-3, and 400-4, respectively. Similarly, circulator 601 receives optical signals 626, 628, and 630 from etalon units 400-2, 400-3, and 400-4, respectively, in a serial manner. Optical signal 630 is redirected by circulator 601 for provision to optical signal acceptor 604 as output signal 632.

FIG. 7 depicts an exemplary group delay response associated with system 600 where the incident position, x, of the various optical signals is the same among the plurality of etalon units 400-1 through 400-4. FIG. 7 depicts group delay al which is associated with etalon unit 400-1; group delay τ₂ which is associated with etalon unit 400-2; group delay τ₃ which is associated with etalon unit 400-3; and group delay τ₄ which is associated with etalon unit 400-4. Since optical signal 620 is applied to etalon units 400-1 through 400-4 in a serial manner by circulator 601, the total group delay equals the sum of the individual group delays, i.e., τ₁+τ₂+τ₃+τ₄. It shall be appreciated that the total group delay for any arbitrary number of etalon units 400 arranged in a cascaded manner may be calculated by summing the individual group delays. FIG. 8 depicts total group delay for a series of incident positions, (e.g., x₁ through x₆) as a function of wavelength. In this approximation, it is seen that total group delay is substantially a linear function of wavelength for each incident position.

FIG. 9 depicts an exemplary dispersion response function associated with system 600. The dispersion (which is the partial derivative of group delay with respect to wavelength as previously noted) varies as a function of incident position, x. Since group delay has been selectively chosen (by effecting the reflective indexes and separation distances of etalons 400-1 through 400-4) to be substantially linear, dispersion therefore becomes substantially constant for a particular incident position, x. Therefore, FIG. 9 represents dispersion as a substantially linear function of incident position, x. However, it shall be appreciated that an actual implementation of system 600 may not produce a perfectly linear device. Accordingly, the linear depiction is an approximation only. In actual implementations, the various parameters (reflective indexes and separation distances) are selected such that dispersion is approximately a monotonic function of the incident position, x.

It shall be appreciated that the reflective indexes and separation distances of etalon units 400-1 through 400-4 may be selectively chosen to achieve a particular group delay response. In one embodiment, the group delay response is selectively chosen such that the dispersion created by system 600 compensates for dispersion caused by other components of the optical network either upstream or downstream from system 600. Additionally, the reflective indexes of etalon units 400-1 through 400-4 are variable as a function of the incident position, x, associated with the optical signal to be compensated. Thus, system 600 may cause group delay to be increased or decreased as desired, thereby achieving tunable dispersion compensation upon an optical signal.

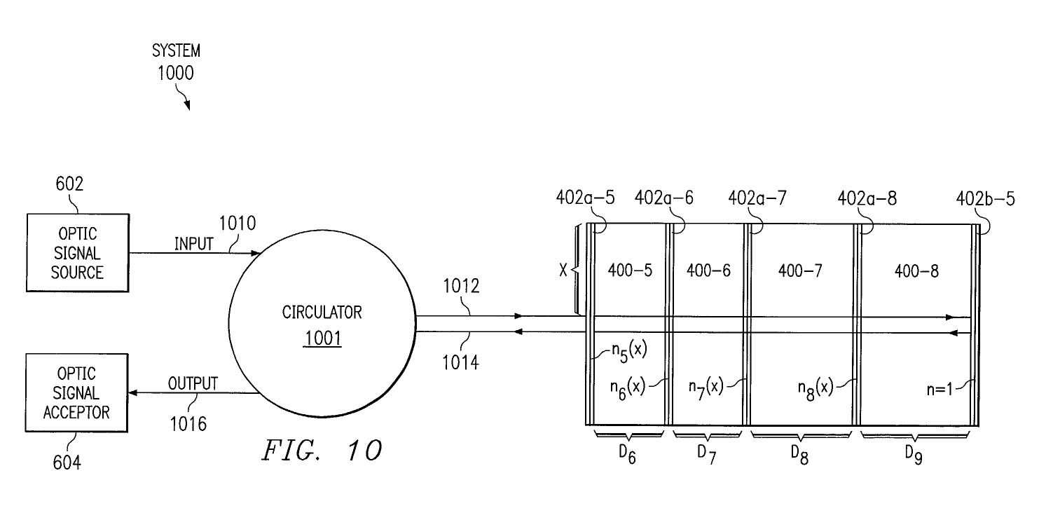

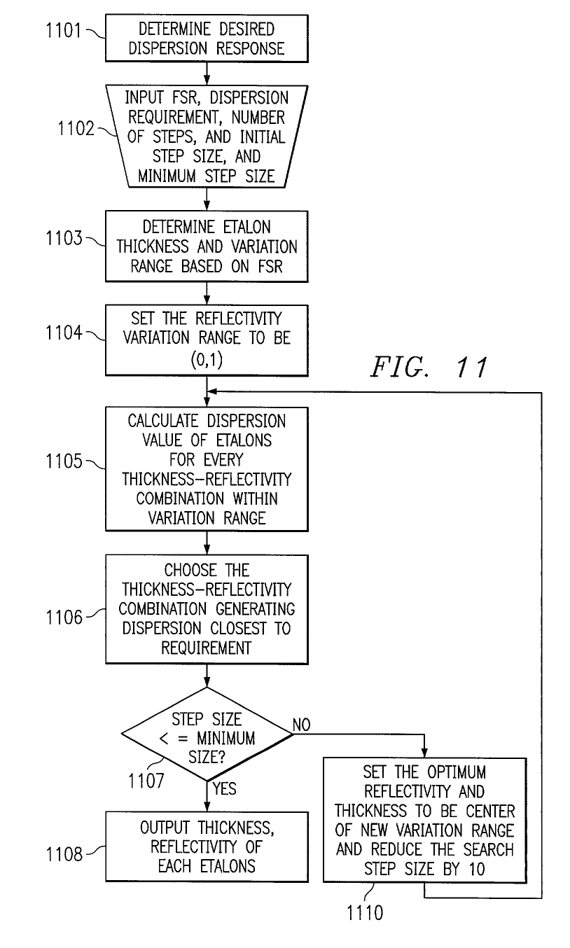

FIG. 10 depicts another embodiment of the present invention. System 1000 comprises optical signal source 602 and optical signal acceptor 604. System 1000 further comprises circulator 1001 communicatively coupled to a series configuration of a plurality of etalon units 400-5 through 400-8. Etalon units 400-5 through 400-8 are formed using a series configuration of reflective surfaces 402a-5, 402a-6, 402a-7, 402a-8 and 402b-5. Additional or fewer etalon units 400 may be formed using a suitable number of reflective surfaces 402a.

Optical signal source 602 provides input optical signal 1010. Optical signal acceptor 604 accepts or receives output optical signal 1016. Circulator 1001 is utilized as a mechanism to achieve spatial separation for the input and output signals. As previously noted, other mechanisms may be utilized to achieve spatial separation, such as a dual fiber collimator and off-angle mirrors or reflective surfaces as examples.

Reflective surfaces 402a-5 through 402a-8 are gradiently coated and possess reflective indexes that are defined by n₅(x) through n₈(x) respectively. The gradient of the reflective indexes associated with reflective surfaces 402a-5 through 402a-8 may be configured according to any suitable function, as described above. Reflective surface 402b-5 possesses a reflective index of approximately one. Accordingly, reflective surface 402b-5 causes almost all of the optical energy that reaches 402b-5 to be reflected. Also, reflective surfaces 402a-5 through 402a-8 and 402b-5 are separated by distances D₅, D₆, D₇, and D₈, respectively.

In operation, circulator 1001 receives optical signal 1010 from optical signal source 602 and redirects optical signal 1010 as optical signal 1012 to the serial arrangement of reflective surfaces 402a-5 through 402a-8 and 402b-5. Optical signal 1012 propagates through reflective surfaces 402a-5, 402a-6, 402a-7, and 402a-8 with portions of optical signal 1012 being reflected and the other portions being allowed to continue propagating. It shall be appreciated that optical resonance occurs with respect to each etalon cavity defined by reflective surfaces 402a-5 through 402a-8 and 402b-5 due to multiple reflections between the various reflective surfaces. Moreover, all or almost all of the energy associated with optical signal 1012 is reflected, since the reflective index of reflective surface 402b-5 is approximately equal to one. Optical signal 1014 represents the superposition of the reflected optical energy from the respective reflective surfaces. Optical signal 1014 is received by circulator 1001 and redirected as output signal 1016 to optical signal acceptor 604. Output signal 1016 is provided tunable group delay by the variation of the incident position, x, of signal 1012, which thereby facilitates dispersion compensation upon signal 1012.

It shall be appreciated that a frequency domain transfer function for system 1000 (i.e., the function defining the relationship between signal 1012 and signal 1014) may be derived. Also, it shall be appreciated that similar transfer functions may be defined for any number of etalon units 400 arranged in a serial configuration. The transfer function for a particular number of etalon units 400 may be utilized to derive the group delay associated with the particular number of etalon units 400. The partial derivative of group delay yields the dispersion response. Additionally, by appropriately selecting the reflective indexes and the separation distances, a dispersion response that is based at least in part upon incident position, x, may be achieved as depicted in FIG. 9.

FIG. 9 represents dispersion as a substantially linear function of incident position, x. However, it shall be appreciated that an actual implementation of system 1000 may not produce a perfectly linear device. Accordingly, the linear depiction is an approximation only. In actual implementations, the various parameters (reflective indexes and separation distances) are selected such that dispersion is a substantially monotonic function of x. The technique for selecting the various parameters to achieve a desired dispersion response is discussed below with respect to FIG. 11.

As previously noted, dispersion compensation is achieved by selectively choosing the various parameters (reflective indexes and separation distances) of the etalon units 400. FIG. 11 depicts an exemplary flowchart for a computer aided etalon parameter selection algorithm arranged according to an embodiment of the present invention. Specifically, the procedure begins by examining the dispersion of the optical media to be compensated (e.g., the dispersion produced by an optical fiber). The known dispersion is used to generate a desired dispersion response for the etalon configuration (step 1101). In one embodiment, the desired dispersion response of the etalon configuration should possess opposite characteristics of the dispersion to be compensated (e.g., opposite in slope and magnitude).

In step 1102, various inputs are received for the subsequent iterative comparison steps. The free spectral range (FSR) is first received. The free spectral range is a well known optical term used to refer to the spectral range between two successive pass bands of an etalon configuration. The number of steps, initial step size, and minimum step size of the iterative comparison process are received.

In step 1103, the etalon separation distances and variation range are determined based upon the free spectral range. In step 1104, the reflectivity variation range is set to be (0, 1). In step 1105, the dispersion value of the etalon configuration is determined for every distance/reflectivity combination within the variation ranges at intervals defined by the step size. The dispersion value is calculated by reference to the group delay and the width of the optical channel(s). Group delay has been explicitly given for the cascaded configuration. Also, group delay is readily derived from the transfer function of a particular serial configuration. In step 1106, the combination of separate distances and the reflective index values that generates dispersion closest to the desired dispersion response is selected.

In step 1107, the iteration loop is performed by examining whether the current step size is less than or equal to the minimum step size. If not, the selected distances and reflective index values are selected as the center of new variation ranges (step 1106). Also, the step size is reduced by a factor of ten. At this point, the iteration process continues by returning to step 1105 utilizing the new variation ranges and the new step size.

If the comparison at step 1107 determines the step size has met the requisite criteria, the selected separation distances and reflective index values of each etalon are provided to be utilized as specification parameters for etalon construction.

Additionally, it shall be appreciated that the preceding etalon configurations of FIGS. 6 and 10 may be modified to provide dispersion slope compensation. Specifically, the etalon configurations may be modified by causing the reflective surfaces, such as surfaces 402a and 402b, to be wavelength dependent. Dispersion slope compensation is shown in FIG. 12. In FIG. 12, several bands (1201, 1202, and 1203) of dispersion response are associated with various wavelengths for a particular incident position, x. Bands 1201, 1202, and 1203 are substantially uniform on an individual basis. However, the dispersion compensation between bands 1201, 1202, and 1203 is varied. Accordingly, this approach is appropriate for multi-channel systems. Specifically, each of bands 1201, 1202, and 1203 may be tailored to provide dispersion compensation to a particular channel of a WDM system. It shall be appreciated that the dispersion response depicted in FIG. 12 is a mathematical simplification. Specifically, actual implementations do not generally present perfectly linear devices. However, FIG. 12 illustrates sufficient detail to illustrate the principle of tunably affecting dispersion slope characteristics of etalon systems to address disparate dispersion associated with different channels of multi-channel optical systems.

It shall be appreciated that the dispersion compensation need not occur after dispersion has actually occurred in an optical media. For example, an optical signal may be subjected to pre-compensation before being placed into an optical media. By causing pre-compensation to occur, the dispersion caused by an optical media will cause the signal received at a destination to be received in its desired form without further processing at the destination.

By utilizing the provided serial or cascaded etalon configurations, dispersion compensation may be obtained by variably translating gradiently coated etalon units 400, thereby causing an optical signal to be variably subjected to different reflective indexes. Moreover, it shall be appreciated that the present invention provides significant advantages over other implementations. First, the present approach provides very low insertion loss. Specifically, very little optical energy is wasted since optical absorption of the reflective surfaces is minimal and the posterior reflective surfaces are almost fully reflective. Furthermore, the present approach is very stable. Environmental effects such as temperature do not substantially affect the optical characteristics of the etalon units 400. Moreover, the present approach is highly reliable.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A dispersion compensator comprising:
a first reflective surface having a gradient reflective index, the first reflective surface operable to receive an input signal at an incident position; and
a second reflective surface;
wherein the first reflective surface and the second reflective surface process the input signal according to a dispersion function that is based at least in part upon the incident position of the input signal.

2. The dispersion compensator of claim 1 wherein:
the first reflective surface reflects a first portion of the input signal;
the second reflective surface reflects a second portion of the input signal; and
the first and second portions of the input signal form a portion of an output signal that is compensated for dispersion according to the dispersion function.

3. The dispersion compensator of claim 2 wherein the dispersion compensation of the output signal is tuned by adjusting the incident position at which the first reflective surface receives the input signal.

4. The dispersion compensator of claim 1 wherein the dispersion function is determined according to a dispersion characteristic associated with an optical component communicatively coupled to the dispersion compensator.

5. The dispersion compensator of claim 1 wherein the dispersion function is a monotonic function with respect to the incident position of the input signal.

6. The dispersion compensator of claim 1 wherein the gradient reflective index varies according to a continuous function.

7. The dispersion compensator of claim 1 wherein the gradient reflective index varies according to a step function.

8. The dispersion compensator of claim 1 wherein the first and second reflective surfaces are arranged among a plurality of reflective surfaces in a cascaded configuration.

9. The dispersion compensator of claim 1 wherein the first and second reflective surfaces are arranged among a plurality of reflective surfaces in a serial configuration.

10. The dispersion compensator of claim 1 wherein:
the incident position of the input signal comprises a first incident position;
the first reflective surface is further operable to receive the input signal at a second incident position; and
the dispersion function is based at least in part upon the second incident position.

11. The dispersion compensator of claim 1 wherein the second reflective surface has a reflective index of one.

12. The dispersion compensator of claim 1 wherein:
the first and second reflective surfaces are separated by a distance; and
the dispersion function is based at least in part upon the distance between the first and second reflective surfaces.

13. The dispersion compensator of claim 1 wherein:
the input signal comprises an optical signal having a plurality of wavelength channels;
the dispersion function is based at least in part upon the wavelength channel of the input signal.

14. The dispersion compensator of claim 1 wherein the dispersion function is based at least in part upon the reflective index of the first reflective surface at the incident position.

15. The dispersion compensator of claim 1 further comprising a third reflective surface having a gradient reflective index, the third reflective surface being disposed between the first reflective surface and the second reflective surface.

16. The dispersion compensator of claim 2 wherein the first reflective surface and the second reflective surface form a first etalon unit, the dispersion compensator further comprising a second etalon unit operable to receive the output signal at a second incident position and to process the output signal according to a second dispersion function that is based at least in part upon the second incident position.

17. The dispersion compensator of claim 16 wherein the first incident position is substantially the same as the second incident position.

18. A method for providing dispersion compensation to an optical signal, comprising:
receiving an input signal at an incident position along a first reflective surface having a gradient reflective index;
reflecting a first portion of the input signal at the first reflective surface;
reflecting a second portion of the input signal at a second reflective surface; and
generating an output signal that comprises the first and second portions of the input signal, wherein the output signal exhibits a dispersion response that is based at least in part upon the incident position of the input signal.

19. The method of claim 18 further comprising tuning the dispersion response of the output signal by adjusting the incident position at which the first reflective surface receives the input signal.

20. The method of claim 18 wherein:
the step of generating an output signal further comprises processing the input signal according to a dispersion function; and
the dispersion response of the output signal is determined according to the dispersion function.

21. The method of claim 18 wherein the dispersion response varies monotonically with respect to the incident position of the input signal.

22. The method of claim 18 wherein the gradient reflective index varies according to a continuous function.

23. The method of claim 18 wherein the gradient reflective index varies according to a step function.

24. The method of claim 18 further comprising arranging the first and second reflective surfaces among a plurality of reflective surfaces in a cascaded configuration.

25. The method of claim 18 further comprising arranging the first and second reflective surfaces among a plurality of reflective surfaces in a series configuration.

26. The method of claim 18 further comprising reflecting a third portion of the input signal at a third reflective surface having a gradient reflective index, wherein the output signal further comprises the third portion of the optical signal.

27. The method of claim 18 wherein the output signal comprises a first output signal, the method further comprising:
receiving the first output signal at an incident position along a third reflective surface having a gradient reflective index;
reflecting a first portion of the first output signal at the third reflective surface;
reflecting a second portion of the first output signal at a fourth reflective surface; and
generating a second output signal that comprises the first and second portions of the first output signal, wherein the second output signal exhibits a dispersion response that is based at least in part upon the incident position of the first output signal.

28. The method of claim 18 wherein the incident position of the input signal comprises a first incident position, the method further comprising receiving the input signal at a second incident position such that the dispersion response of the output signal is based at least in part upon the second incident position.

29. The method of claim 18 wherein the second reflective surface has a reflective index of one.

30. The method of claim 18 wherein:
the first and second reflective surfaces are separated by a distance; and
the dispersion response of the output signal is based at least in part upon the distance between the first and second reflective surfaces.

31. The method of claim 18 wherein:
the input signal comprises an optical signal having a plurality of wavelength channels;
the dispersion response of the output signal is based at least in part upon the wavelength channel of the input signal.

32. The method of claim 18 wherein the dispersion response of the output signal is based at least in part upon the reflective index of the first reflective surface at the incident position.

33. A dispersion compensator, comprising:
a first reflective surface having a gradient reflective index and operable to receive an input signal at an incident position;
a second reflective surface having a gradient reflective index and being arranged substantially parallel to the first reflective surface; and
a third reflective surface arranged substantially parallel to the second reflective surface;
wherein the first, second, and third reflective surfaces are operable to process the input signal according to a dispersion function that is based at least in part upon the incident position of the input signal.

34. The dispersion compensator of claim 33, wherein:
the first reflective surface reflects a first portion of the input signal;
the second reflective surface reflects a second portion of the input signal;
the third reflective surface reflects a third portion of the input signal; and
the first, second, and third portions of the input signal form a portion of an output signal that is compensated for dispersion according to the dispersion function.

35. The dispersion compensator of claim 34 wherein the dispersion compensation of the output signal is tuned by adjusting the incident position at which the first reflective surface receives the input signal.

36. The dispersion compensator of claim 33 wherein the dispersion function is determined according to a dispersion characteristic associated with an optical component communicatively coupled to the dispersion compensator.

37. The dispersion compensator of claim 33 wherein the dispersion function is a monotonic function with respect to the incident position of the input signal.

38. The dispersion compensator of claim 33 wherein the gradient reflective index of at least one of the first and second reflective surfaces varies according to a continuous function.

39. The dispersion compensator of claim 33 wherein the gradient reflective index of at least one of the first and second reflective surfaces varies according to a step function.

40. The dispersion compensator of claim 33 wherein:
the incident position of the input signal comprises a first incident position;
the first reflective surface is further operable to receive the input signal at a second incident position; and
the dispersion function is based at least in part upon the second incident position.

41. The dispersion compensator of claim 33 wherein the third reflective surface has a reflective index of one.

42. The dispersion compensator of claim 33 wherein:
the first and second reflective surfaces are separated by a first distance;
the second and third reflective surfaces are separated by a second distance; and
the dispersion function is based at least in part upon the first distance and the second distance.

43. The dispersion compensator of claim 33 wherein:
the input signal comprises an optical signal having a plurality of wavelength channels;
the dispersion function is based at least in part upon the wavelength channel of the input signal.

44. The dispersion compensator of claim 33 wherein the dispersion function is based at least in part upon the reflective index of the first reflective surface at the incident position.

45. A dispersion compensator, comprising:
a first etalon unit comprising:
a first reflective surface having a gradient reflective index, the first reflective surface operable to receive a first optical signal at an incident position; and
a second reflective surface;
wherein the first reflective surface and the second reflective surface process the first optical signal to generate a second optical signal, the second optical signal having a dispersion response that is based at least in part upon the incident position of the first optical signal; and
a second etalon unit comprising:
a third reflective surface having a gradient reflective index, the third reflective surface operable to receive the second optical signal at an incident position; and
a fourth reflective surface;
wherein the third reflective surface and the fourth reflective surface process the second optical signal to generate a third optical signal, the third optical signal having a dispersion response that is based at least in part upon the incident position of the second optical signal.

46. The dispersion compensator of claim 45 wherein:
the first reflective surface reflects a first portion of the first optical signal;
the second reflective surface reflects a second portion of the first optical signal; and
the first and second portions of the first optical signal form a portion of the second optical signal.

47. The dispersion compensator of claim 45 wherein:
the third reflective surface reflects a first portion of the second optical signal;
the fourth reflective surface reflects a second portion of the second optical signal; and
the first and second portions of the second optical signal form a portion of the third optical signal.

48. The dispersion compensator of claim 45 wherein the dispersion response of at least one of the second and third optical signals is determined according to a dispersion characteristic associated with an optical component communicatively coupled to the dispersion compensator.

49. The dispersion compensator of claim 45 wherein the dispersion response of the second optical signal varies monotonically with respect to the incident position of the first input signal.

50. The dispersion compensator of claim 45 wherein the gradient reflective index of at least one of the first and third reflective surfaces varies according to a continuous function.

51. The dispersion compensator of claim 45 wherein the gradient reflective index of at least one of the first and third reflective surfaces varies according to a step function.

52. The dispersion compensator of claim 45 wherein:
the incident position of the first optical signal comprises a first incident position;
the first reflective surface is further operable to receive the first optical signal at a second incident position; and
the dispersion response of the second optical signal is based at least in part upon the second incident position.

53. The dispersion compensator of claim 45 wherein at least one of the second and fourth reflective surfaces has a reflective index of one.

54. The dispersion compensator of claim 45 wherein:
the first and second reflective surfaces are separated by a distance; and
the dispersion response of the second optical signal is based at least in part upon the distance between the first and second reflective surfaces.

55. The dispersion compensator of claim 45 wherein:
the first optical signal comprises a plurality of wavelength channels;
the dispersion response of the second optical signal is based at least in part upon the wavelength channel of the first optical signal.

56. The dispersion compensator of claim 45 wherein the dispersion response of the second optical signal is based at least in part upon the reflective index of the first reflective surface at the incident position of the first optical signal.

57. The dispersion compensator of claim 45 wherein the dispersion response of the second optical signal is tuned by adjusting the incident position at which the first reflective surface receives the first optical signal.

58. The dispersion compensator of claim 45 wherein the dispersion response of the third optical signal is tuned by adjusting the incident position at which the third reflective surface receives the second optical signal.
